(19) United States
(12) Patent Application Publication
(10) Pub. No.: US 2006/0073809 A1
(43) Pub. Date: Apr. 6, 2006

(54) Online loyalty program

(76) Inventors: Jeanette Juetten, Sun Prairie, WI (US); Todd Gundrum, Cross Plains, WI (US); Cindy Rink, Madison, WI (US); Renee Anderson, Monona, WI (US); Cindy Hollenstein, Waunakee, WI (US); John Krejcarek, Madison, WI (US); Tiffany Neely, Madison, WI (US); Sean Reynolds, Middleton, WI (US); Bill Ziche, Belleville, WI (US); Glenn Christenson, Bayside, WI (US)

Correspondence Address: KOLISCH HARTWELL, P.C., 200 PACIFIC BUILDING, 520 SW YAMHILL STREET, PORTLAND, OR, 97204, US

(21) Appl. No.: 11/236,281

(22) Filed: Sep. 26, 2005

Related U.S. Application Data
(60) Provisional application No. 60/612,689, filed on Sep. 24, 2004.

(51) Int. Cl. H04M 11/00

(52) U.S. Cl. 455/406

(57) ABSTRACT

A system for increasing consumer affinity for a brand associated with a sponsor, comprising a server computer hosting a Web site. The server computer enables a user and a sub-user affiliated with the user to access the Web site over a computer network through a client computer and stores data in a database, including a user account having a reward point balance associated therewith for the user, and one or more sub-user accounts affiliated with the user account, each affiliated sub-user account having a reward point balance associated therewith for the affiliated sub-user. The server computer enables the sponsor to credit one or more reward points to the user account and to credit one or more reward points to the affiliated sub-user account. The server computer enables the user to distribute one or more reward points from the user account to at least one of the affiliated sub-user accounts and enables the affiliated sub-user to redeem one or more reward points to the sponsor in exchange for merchandise.

### CROSS-REFERENCE TO RELATED APPLICATION

The present application claims priority from U.S. Provisional Patent Application Ser. No. 60/612,689, filed Sep. 24, 2004, which is incorporated herein by reference in its entirety for all purposes.

### BACKGROUND

The present disclosure is related to an activity based, online loyalty program. More specifically, the program is designed to increase consumer affinity for a brand of products and/or services by recognizing and rewarding participants enrolled in the program. As is well known, sellers of branded products and services make efforts to increase consumer awareness of their brand. Such efforts include general advertising, which typically amounts to various attempts to inject indicia associated with the brand into the perception of the consuming public, typically with an intention that the consumers make favorable associations regarding the brand. However, within the ever-crowded marketplaces for many consumer goods, brand owners often must make extra efforts to increase consumer affinity for their brand—that is to make consumers more aware of, and more interested in, the brand and its associated goods and/or services.

One such effort to increase consumer affinity for a brand may be in the form of a loyalty program, wherein the brand owner, or an agent thereof, provides some form of reward or other benefit in recognition of repeat business with the brand owner. Such a program has the effect of increasing consumer affinity for the brand because participating consumers will be more likely to further engage the brand, such as by making continued or increasing numbers of purchases of the branded goods and or services, in an effort to maximize the reward the consumer may extract from the brand. Examples of such programs include airline frequent-flyer programs and coffee shop punch cards (e.g., buy 10, get 1 free) where the brand owner provides a reward to the consumer in exchange for repeat purchases by the consumer. Although such rewards (i.e., the free products) are typically factored into the cost of the purchased services, consumers typically focus on the perceived free reward to be received based on continued purchases. Continued participation in the program will typically be motivated at least partly by the potential for continued rewards.

Some loyalty programs may be styled as an exclusive club in that “membership” is required. While memberships might be provided free of charge to members, some loyalty programs may provide a membership for a nominal price. Such a membership then provides access to the benefits of the club. Typically, club benefits should at least partially provide motivation to the club members to purchase further products and/or services from the brand owner.

By their very nature, some goods and/or services may be targeted towards ultimate users who may be distinct from the intended purchaser. In particular, goods and/or services intended for ultimate use by children may actually be purchased by a person other than the child, such as a parent, guardian, friend, or other relative of the child. In such cases, the advertising, as well as the loyalty program may be targeted at the child, who may then persuade the other person to purchase the branded goods and/or services for the child's benefit.

With the current prevalence of the Internet and World Wide Web in everyday life, loyalty programs may partially or completely include an online or Web based component. However, unsupervised use of online services may pose risks to children.

Examples of online programs are found in: WO013788; WO0188822; U.S. patent application Publication Nos. 2001/0054003, 2002/0002485, 2002/0042744, 2002/0046116, 2002/0062253, 2002/0077904, 2002/0082918, 2002/0099601, 2002/0143626, 2002/0147633, 2002/0178056, 2002/0188509, 2003/0050831, 2003/0130895, 2003/0200141, 2003/0200144, 2003/0204417, 2003/0212596, 2004/0043806, 2004/0073488, 2004/0167815, 2004/0177001, 2004/0193485, 2004/0243468, and 2005/0043992; and U.S. Pat. Nos. 5,832,457, 6,178,408, 6,178,407, 6,206,750, 6,224,486, 6,251,017, 6,280,325, 6,325,292, 6,389,401, 6,419,577, 6,450,407, and 6,484,147, the disclosures of which are hereby incorporated by reference in their entirety for all purposes.

### SUMMARY OF THE DISCLOSURE

An online loyalty program may include a system for increasing consumer affinity for a brand associated with a sponsor. The system may comprise a server computer hosting a Web site. The server computer may enable a user and a sub-user affiliated with the user to access the Web site over a computer network through a client computer. The server computer may store data in a database, wherein the data may comprise a user account having a reward point balance associated therewith for the user and one or more sub-user accounts, which may be affiliated with the user account. Each affiliated sub-user account may have a reward point balance associated therewith for the affiliated sub-user. The server computer may enable the sponsor to credit one or more reward points to the user account, such as in exchange for the user performing a first activity, which may be defined by the sponsor. The server computer may enable the sponsor to credit one or more reward points to the affiliated sub-user account, such as in exchange for the affiliated sub-user performing a second activity, which may be defined by the sponsor. The server computer may enable the user to distribute one or more reward points from the user account to at least one of the affiliated sub-user accounts. The server computer may enable the affiliated sub-user to redeem one or more reward points to the sponsor, such as in exchange for merchandise.

An online loyalty program may include a method for increasing consumer affinity for a brand associated with a sponsor. The method may comprise providing a server computer accessible over a computer network. The method may comprise storing data on the server computer in a database. The database may comprise a user account having a reward point balance associated therewith for a user and one or more sub-user accounts, which may be affiliated with the user account. Each affiliated sub-user account may have a reward point balance associated therewith for a sub-user affiliated with the user. The method may comprise crediting one or more reward points to the user account, such as in exchange for the user performing an activity, which may be defined by the sponsor. The method may comprise transferring, such as at the request of the user, one or more reward points from the user account to at least the one affiliated sub-user account. The method may comprise crediting one or more reward points to at least the one affiliated sub-user account, such as in exchange for the affiliated sub-user performing an activity, which may be defined by the sponsor. The method may comprise redeeming, such as at the request of the affiliated sub-user, one or more reward points from at least the one affiliated sub-user account to the sponsor, such as in exchange for merchandise.

An online loyalty program may include storage media, which may have embodied therein a plurality of machine-readable instructions. When a processor executes the instructions, the instructions may provide for storing data, such as on a server computer, such as in a database. The database may comprise a user account having a reward point balance associated therewith for a user and one or more sub-user accounts, which may be affiliated with the user account. Each affiliated sub-user account may have a reward point balance associated therewith for a sub-user affiliated with the user. The instructions may provide for crediting one or more reward points to the user account, such as in exchange for the user performing an activity, which may be defined by the sponsor. The instructions may provide for transferring, such as at the request of the user, one or more reward points from the user account to at least the one affiliated sub-user account. The instructions may provide for crediting one or more reward points to at least the one affiliated sub-user account, such as in exchange for the affiliated sub-user performing an activity, which may be defined by the sponsor. The instructions may provide for redeeming, such as at the request of the affiliated sub-user, one or more reward points from at least the one affiliated sub-user account to the sponsor, such as in exchange for merchandise.

An online loyalty program may include storage media, which may have embodied therein a plurality of machine-readable instructions that may be adapted to be executed by a computer processor. When the computer processor executes the instructions, the instructions may enable a user and a sub-user affiliated with the user to access a Web site, such as over a computer network through a client computer. When the computer processor executes the instructions, the instructions may store data in a database. The data may comprise a user account, which may have a reward point balance associated therewith for the user, and one or more sub-user accounts, which may be affiliated with the user account. Each affiliated sub-user account may have a reward point balance associated therewith for the affiliated sub-user. When the computer processor executes the instructions, the instructions may enable the sponsor to credit one or more reward points to the user account, such as in exchange for the user performing a first activity, which may be defined by the sponsor. When the computer processor executes the instructions, the instructions may enable the sponsor to credit one or more reward points to the affiliated sub-user account, such as in exchange for the affiliated sub-user performing a second activity, which may be defined by the sponsor. When the computer processor executes the instructions, the instructions may enable the user to distribute one or more reward points from the user account to at least one of the affiliated sub-user accounts. When the computer processor executes the instructions, the instructions may enable the affiliated sub-user to redeem one or more reward points to the sponsor, such as in exchange for merchandise.

An online loyalty program may include a system for increasing consumer affinity for a brand. The system may comprise a server hosting an online environment that may be accessible, such as by a user and a sub-user affiliated with the user. The server may be configured to enable the user to supervise the online activities of the affiliated sub-user. The server may be configured to issue one or more reward points to the user. The server may be configured to enable the user to transfer one or more reward points from the user to the affiliated sub-user. The server may be configured to issue one or more reward points to the affiliated sub-user, such as in exchange for the affiliated sub-user performing an activity, which may be specified by the online environment. The server may be configured to enable the affiliated sub-user to redeem one or more reward points, such as in exchange for branded merchandise, which may be from an owner of the brand. The server may be configured to provide an online forum that may enable the affiliated sub-user to communicate with one or more other sub-users. The server may be configured to enable the user to supervise the content of messages that may be sent and received by the affiliated sub-user, such as through the online forum. The server may be configured to enable the user to control to which of the one or more other sub-users the affiliated sub-user may transmit messages, such as through the online forum. The server may be configured to enable the user to control from which of the one or more other sub-users the affiliated sub-user may receive messages, such as through the online forum. The server may be configured to maintain a database, which may store interests that may be associated with the affiliated sub-user and at least one of the one or more other sub-users. The server may be configured to enable the affiliated sub-user to access the database, such as to select other sub-users whom the affiliated sub-user desires to engage in communication.

An online loyalty program may include a method for increasing consumer affinity for a brand associated with a sponsor. The method may comprise providing a server hosting an online environment. The online environment may enable a user to supervise the activities of an affiliated sub-user, such as within the online environment. The method may comprise issuing one or more reward points to the user. The method may comprise transferring, such as at the request of the user, one or more reward points of the user to the affiliated sub-user. The method may comprise issuing one or more reward points to the affiliated sub-user, such as in exchange for the affiliated sub-user performing an activity, which may be specified by the sponsor. The method may comprise redeeming, such as at the request of the affiliated sub-user, one or more reward points of the affiliated sub-user, such as in exchange for branded merchandise from an owner of the brand. The method may comprise providing an online forum, which may enable the affiliated sub-user to communicate with one or more other sub-users. The online forum may enable the user to review the content of messages, such as those transmitted and received by the affiliated sub-user. The online forum may enable the user to select other sub-users to whom the affiliated sub-user may transmit messages. The online forum may enable the user to select other sub-users from whom the affiliated sub-user may receive messages. The method may comprise maintaining a database on a computer, which may be accessible over a computer network. The database may include interests, such as those associated with the affiliated sub-user and at least one of the one or more other sub-users. The method may comprise enabling the affiliated sub-user to access the database, such as through the online environment. The method may comprise enabling the affiliated sub-user to select other sub-users, such as those with whom the affiliated sub-user may desire to exchange messages using the online forum.

An online loyalty program may include a system for increasing consumer affinity for a brand associated with a sponsor. The system may comprise a server computer hosting a Web site, which may be accessible over a computer network. The server computer may be configured to provide sub-user access to the Web site, such as through a client computer, which may be connected to the computer network. The Web site may enable a sub-user affiliated with a user to exchange messages, such as with one or more other sub-users. The server computer may be configured to provide user access to the Web site, such as through a client computer, which may be connected to the computer network. The Web site may enable the user to exercise control over the affiliated sub-user's exchange of messages, such as with one or more other sub-users. The server computer may be configured to store, such as in a database, a message list associated with the user. The message list may include one or more exchanged messages, which may be subject to the user's control.

An online loyalty program may include a method for increasing consumer affinity for a brand. The method may comprise providing a Web site, which may be hosted on a server computer, which may be in communication with a computer network. The method may comprise providing a messaging interface on the Web site, which may enable a sub-user affiliated with a user to exchange messages, such as with one or more other sub-users. The method may comprise providing a messaging supervision interface, which may be on the Web site, which may enable the user to supervise messages, such as those exchanged between the affiliated sub-user and one or more other sub-users. The method may comprise storing data, such as in a database, which may be on a computer, which may be in communication with the server computer. The database may comprise a user file associated with the user and may include a message history, which may include messages, such as those exchanged by the affiliated sub-user.

An online loyalty program may include storage media, which may have embodied therein a plurality of machine-readable instructions. When a processor executes the instructions, the instructions may provide for providing a Web site, which may be hosted on a server computer, which may be in communication with a computer network. The instructions may provide for providing a messaging interface, which may be on the Web site, which may enable a sub-user affiliated with a user to exchange messages, such as with one or more other sub-users. The instructions may provide for providing a messaging supervision interface, which may be on the Web site, which may enable the user to supervise messages, such as those exchanged between the affiliated sub-user and one or more other sub-users. The instructions may provide for storing data, such as in a database, which may be on a computer, which may be in communication with the server computer. The database may comprise a user file, such as one associated with the user, which may include a message history, which may include messages, such as those exchanged by the affiliated sub-user.

An online loyalty program may include a storage media, which may have embodied therein a plurality of machine-readable instructions, which may be adapted to be executed by a computer processor. When the computer processor executes the instructions, the instructions may provide sub-user access, such as to a Web site, such as through a client computer, which may be connected to a computer network. The Web site may enable a sub-user affiliated with a user to exchange messages, such as with one or more other sub-users. When the computer processor executes the instructions, the instructions may provide user access, such as to the Web site, such as through a client computer, which may be connected to the computer network. The Web site may enable the user to exercise control over the affiliated sub-user's exchange of messages, such as with one or more other sub-users. When the computer processor executes the instructions, the instructions may provide for storing in a database a message list associated with the user. The message list may include one or more exchanged messages, such as those which may be subject to the user's control.

### BRIEF DESCRIPTION OF THE DRAWINGS

FIG. 1 is a schematic diagram of an online loyalty program.

FIG. 2 is a data flow diagram of an online loyalty program.

FIGS. 3A and 3B illustrate a data flow diagram of an online loyalty program.

FIG. 4 is a schematic diagram of an online loyalty program.

FIGS. 5A to 5D illustrate a flow chart for an outgoing messaging system.

FIG. 6 is a flow chart for a determination feature of the outgoing messaging system of FIGS. 5A to 5D.

FIGS. 7A to 7D illustrate a flow chart for an incoming messaging system.

### DETAILED DESCRIPTION

A loyalty program may include various combinations of online and offline features. The online features of a loyalty program may be designed to encourage consumer loyalty to one or both of the online loyalty program and the brand name, and may comprise one or more of: (1) initial rewards a participant may obtain upon initial enrollment in the program, which may include products and coupons for additional products and/or access to services, which may tend to encourage further engagement with the brand; (2) additional rewards a participant may attain, such as by parents and/or children enrolled in the program via continued engagement with both the online program and with the associated brand of products and/or services; (3) increased access to a range of online content, which may be offered such as to parents and/or children enrolled in the program; and (4) security features and safeguards such as to provide children with a safe online environment.

Initial registration with the online loyalty program may be undertaken in any suitable manner, such as at a physical location or online, such as over the Internet via a Web site accessible to the general public. Upon initial enrollment in an online loyalty program, which may be in exchange for a marginal fee, consumers may receive some tangible branded product(s) and a membership card. In some cases, the product(s) may be such as to encourage further participation in the program or loyalty in the brand name, such as by earning or buying additional branded products. As a further incentive for enrolling in the program, participants may receive coupons for branded products.

After enrollment, participants may be provided with incentives to participate and engage in the program in order to obtain additional rewards. For example, participants may receive customizable printable certificates from the program as a reward for engaging in the program. In some embodiments, some classes of consumers, such as parents, may have access to customizable printable certificates that may be given to members of another class of consumers, such as a child, as a reward for good behavior. Participants may also be given motivation to encourage others to enroll in the program, such as by providing participants with a reward such as a coupon for the sponsor's brand of products and/or services, in exchange for providing contact information for other potential participants.

Loyalty program may be configured as an activity based, on-line loyalty program, which may include a series of participant accounts maintained on a database such as one administered by the sponsor or related entity. Various features of the program may be designed to encourage continued or increased participant loyalty to the targeted brand, such as through further participation in the program. Exemplary features of such a program may include a reward subsystem for encouraging participant engagement with the brand or a messaging subsystem providing a communication pathway between one or more participants.

The online loyalty program may be configured to provide a safe online environment, such as for minor participants. As such, the program may provide various communal aspects, but the program may also include sufficient security features and/or safeguards to assure the program complies with the Children's Online Privacy Protection Act of 1998 (“COPPA”). For example, participation in the program by a minor may require that the parents or guardian of that minor obtain any registration in the program. The parents or guardian of any minor participants may need to verbally verify, such as by telephone, their registration with a customer service entity associated with the sponsor of the online club. Verbal verification of registration may require the parent or guardian to provide identifying and/or contact information. Verification of registration may need to be made within a specified time, such as within ten days following activation of a participant's registration. The program may provide participants with reminders of the need to verify registration, such as reminders posted on the program's Web site. Failure to verify registration may result in inactivation of the participant's registration. Participation in the program's online activities may be restricted to registered club members, and access to a Web site embodying the online portions of the program may require authentication such as a login/username and password, or the like.

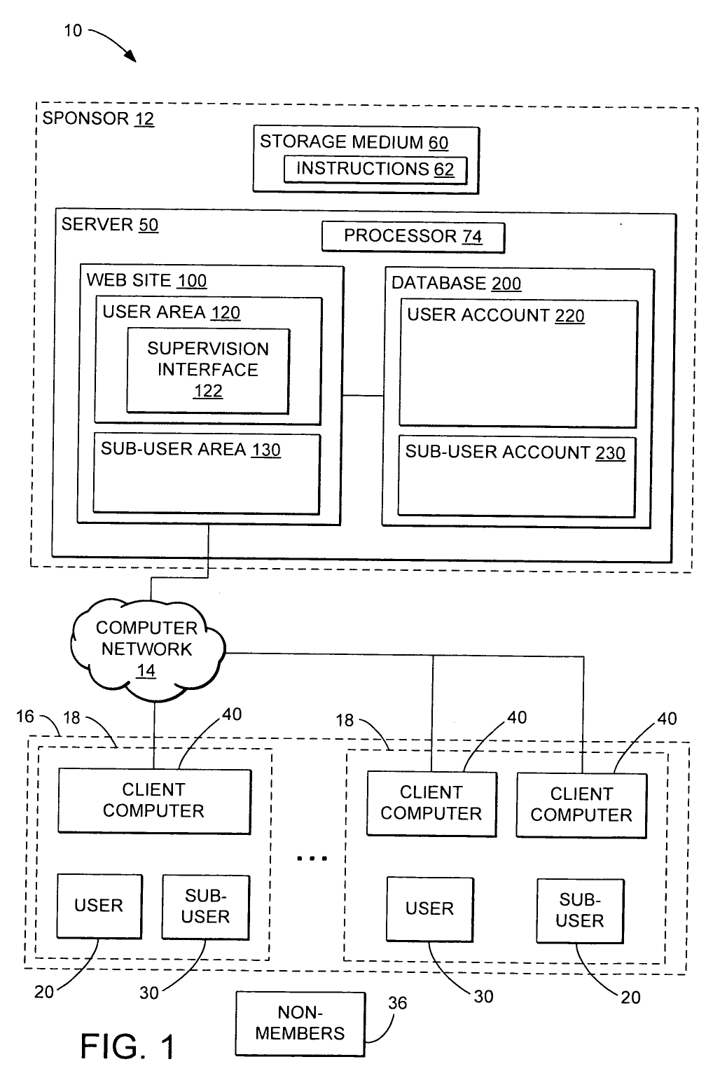

FIG. 1 schematically illustrates an embodiment of system 10 for increasing consumer affinity for a brand, which may comprise at least part of an online loyalty program 1. Participants in system 10 may include a sponsor 12, which may be a brand owner or an agent of a brand owner such as an entity engaged to provide and administer 10 on behalf of the brand owner, one or more users 20, and one or more sub-users 30. Sponsor 12 may include a server computer 50, which may include a processor 74. Server computer 50 may be any suitable computer capable of reading or otherwise accessing a set of instructions 62, such as a set of machine readable instructions, that may be stored or embodied on a suitable storage medium 62, such as a fixed memory or a removable medium, such as a floppy disk, CD-ROM, DVD-ROM, Flash Drive, or the like. Storage medium 62 need not be physically located proximate server 50, so long as server 50 may access storage medium 62 such that processor 74 may execute the instructions 62. Instructions 62 may be configured such as to provide a system 10 for increasing consumer affinity of a brand, as will be described herein, such as when processor 74 executes instructions 62.

The server computer 50 may be connected to a computer network 14 such that the server computer 50 may communicate with one or more suitable client computers 40. Computer network 14 may be any suitable network over which a plurality of computers may communicate, such as a local area network (LAN), a wide area network (WAN), a hardwired or a wireless network, the Internet, or the like. The one or more suitable client computers 40 may be any device capable of communicating with server computer 50 over the computer network 14. Examples of such devices include personal computers, PDAs, laptop computers, wireless devices, such as cellular phones or the like, and any other suitable device that may communicate over computer network 14.

Server computer 50 may host a Web site 100, which may comprise at least part of the online loyalty program 1. Web site 100 may be accessible over computer network 14 by a one or more users 20 and one or more sub-users 30 through one or more client computers 40 connected to computer network 14. Each user 20 may have at least one sub-user 30 affiliated therewith such that the user 20 and the sub-users 30 affiliated therewith may comprise a member entity 18. As shown in FIG. 1, each member entity 18 may include at least one user 20 and at least one sub-user 30, each of whom may access Web site 100 through computer network 14 utilizing a client computer 40. The one or more users 20 and one or more sub-users 30 comprising each member entity 18 may access Web site 100 using one or more client computers 40. The user 20 and sub-user 30 affiliated therewith may each access Web site 100 using a single client computer 40, or the user 20 and sub-user 30 affiliated therewith may each access the Web site 100 using one or more of a plurality of client computers 40 to which the member entity 18 has access.

Access to Web site 100 may be limited to only the one or more member entities 18. The plurality of member entities 18 comprise a group 16 of member entities 18, which may comprise the scope of users 20 and sub-users 30 who may access the Web site 100. Entities who may be prevented from accessing Web site 100, and may thereby be excluded from access to system 10 and participation in the online loyalty program 1, comprise one or more non-members 36, which may be entities who could, if they were part of a member entity, act as either a user or sub-user.

In order to control access to Web site 100, and to system 10, system 10 may include any suitable method or device for authenticating an entity as being either a user 20 or sub-user 30. Examples of such methods include providing each user 20 and sub-user 30 with a login name and a password or use of a physical access key, which may only be issued to users 20 and sub-users 30. Each user 20 and sub-users 30 affiliated therewith, may share a login name and password, or the user 20 and the sub-users 30 affiliated therewith may have separate and distinct login names and passwords. The user 20 may have a record of or other access to the password and/or login name of one or more of the sub-users 30 affiliated with that user. The login names assigned to or chose by each sub-user may be required to include at least one non-alphabetical character, such as a number.

System 10 may only recognize an entity that has provided the proper login or authentication credentials. Thus, any entity providing the login credentials associated with any specific user 20 may be recognized by system 10 as being that user, regardless of the entity that actually provided the credentials. Similarly, any entity providing the login credentials associated with any specific sub-user 30 may be recognized by system 10 as being that sub-user, regardless of the entity that actually provided the credentials.

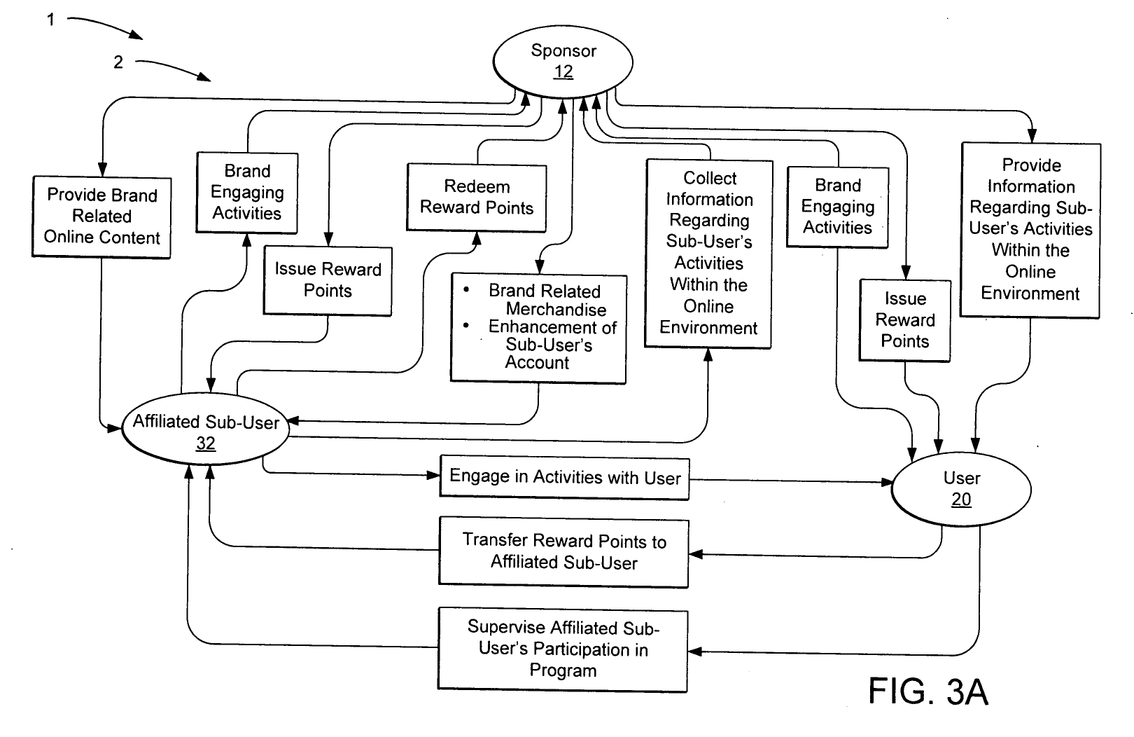

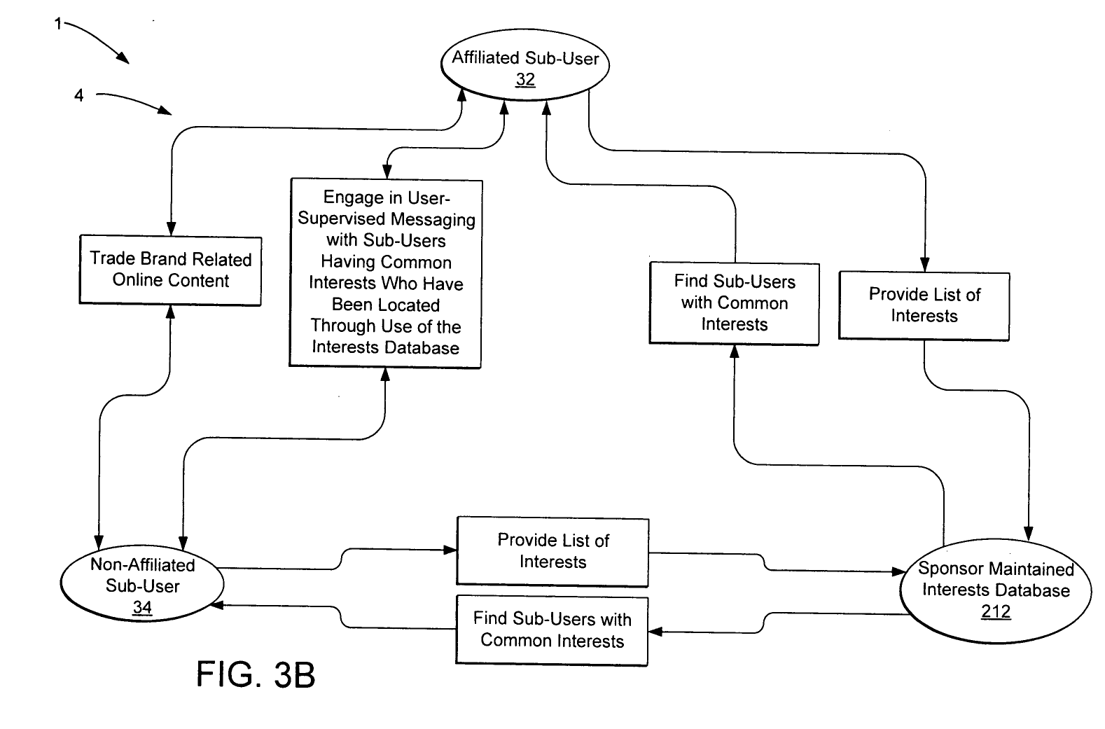

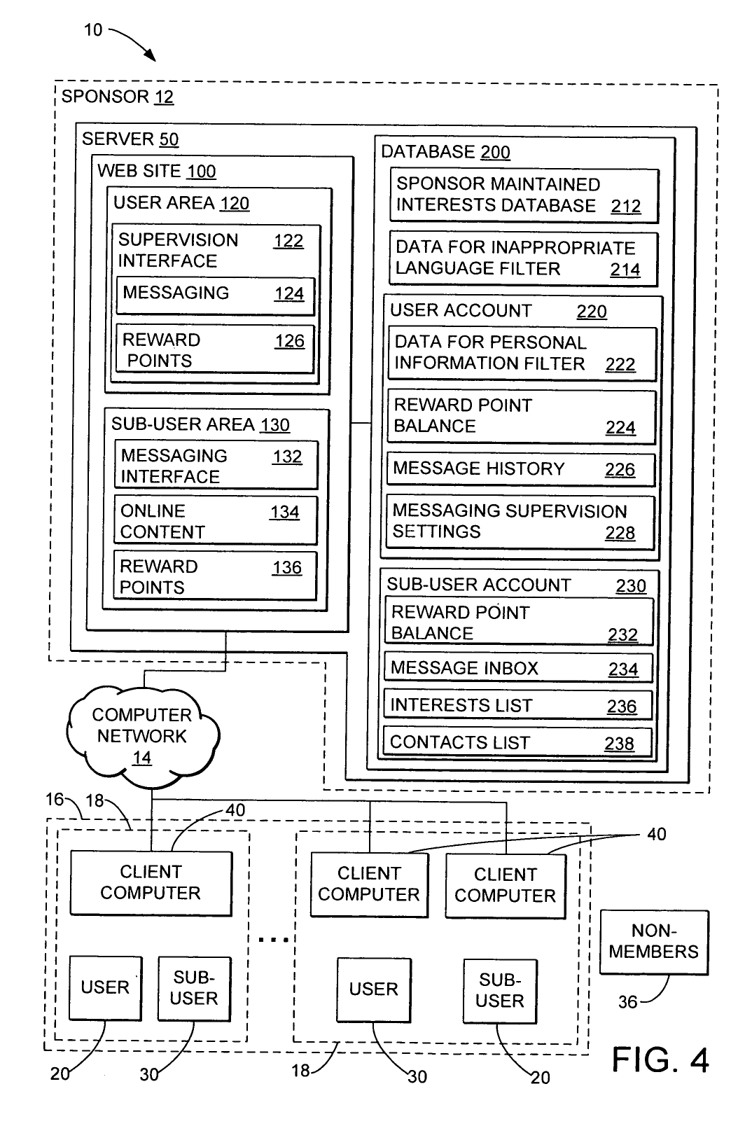

As will be discussed more fully below, with reference to FIGS. 3-4B, each sub-user 30 may be affiliated with only one user 20. Thus, with respect to the user 20 with whom a given sub-user is affiliated, that sub-user may be labeled as an affiliated sub-user 32. Conversely, with respect to the one or more users 20 with whom a given sub-user is not affiliated, that sub-user may be labeled as a non-affiliated sub-user 34. With respect to system 10, the distinctions between users 20, sub-users 30, affiliated sub-users 32 and non-affiliated sub-users 34 may be determined based on the login name and password provided by an entity when attempting to access Web site 100 over computer network 14.

Entities who may be provided with a login name and password identifying them as a user may be members of a class of entities who stand in a predefined relationship, external to system 10, with one or more members of the class of entities who may be provided with a login name and password identifying them as a sub-user. Members of the class of entities provided with user credentials may be entities who can or do act in a position of authority relative to one or more members of the class of entities provided with sub-user credentials. For example, members of the class of entities provided with user credentials may be parents while the class of entities provided with sub-user credentials may be children. In such a case, user 20 could be a parent or guardian while the sub-user 30 affiliated with that user 20—an affiliated sub-user 34—may be that parent's child. In a family environment, where a child may have more than one parent or guardian, any parent or guardian of that child may act as the user affiliated with the sub-user representing the child because system 10 may recognize users and sub-users by the provided login or authentication credentials and there may be only one user affiliated with a given sub-user. Any one of a plurality of children affiliated with a particular parent or parents, or guardian or guardians, may have separate login or authentication credentials as a sub-user affiliated with the user representing the parent(s) or guardian(s).

Another example of classes of entities standing in a relationship suitable for providing respective user and sub-user access may include primary consumers and affiliated secondary consumers. A primary consumer could be an entity who may actually purchase branded products or services from any number of commercial or other sources, or make purchasing decisions, while a secondary consumer could be an ultimate consumer who might be the actual user of the branded products or services that may have been purchased by the primary consumer. Because the primary consumer may have the authority to decide whether to acquire branded products or services for the secondary consumer, the primary consumer may be suited to act as a user relative to the secondary consumer, who may be suited to act as an affiliated sub-user relative to the primary consumer acting as a user.

Another example of classes of entities standing in a relationship suitable for providing respective user and sub-user access may include employers and employees. The employer could act as a user with respect to one or more employees of that employer, who could act as affiliated sub-users. While acting as a user, the employee may want to supervise the actions of the employee acting as an affiliated sub-user.

Web site 100 may include a user area 120 and a sub-users area 130. Access to the user area 120 may be restricted to users 20, while access to the sub-user area 130 may be restricted to sub-users 30. The users area 120 of Web site 100 may include a supervision interface 122, which may enable a user 20 to supervise the activities of an affiliated sub-user, such as within the sub-user area 130.

Server 50 may include a database 200, which may store data related to system 10 and/or online loyalty program 1. Examples of such data may include records related to one or more of the users 20 and sub-users 30. Within database 200, there may be one or more user accounts 220, each of which may be associated with a user 20, and one or more sub-user accounts 230, each of which may be associated with a sub-user 30.

Each of the plurality of user accounts may store information relating to the user 20 with which the user account 220 is associated. Each of the plurality of users accounts may store information relating to one or more of the sub-users affiliated with the user 20, such as data related to the affiliated sub-user's activities within the sub-user area 130 of the Web site 100. The user account 220 may include the login name and password of any sub-users affiliated with the user. The supervision interface 122 of Web site 100 may allow user 20 to access any such data related to the affiliated sub-user's activities within the sub-user area 130 of the Web site 100.

Each of the plurality of sub-user accounts may store information relating to the sub-user 30 with which the sub-user account 230 is associated. Examples of such information may include records of the sub-user's activities within the sub-user area 103 of Web site 100. The sub-user 30 may be able to access the data in the sub-user account 230 associated with that sub-user through the sub-user area 130 of the Web site. The data stored within the sub-user account 230 of an affiliated sub-user 32 may also be accessible by the user affiliated with that sub-user through the supervision interface 122.

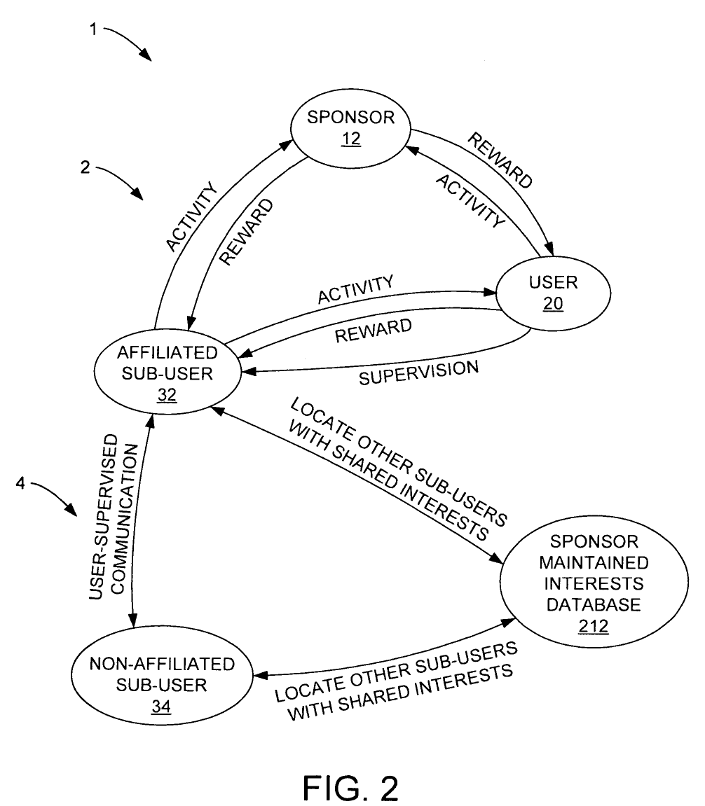

FIG. 2 is a data flow diagram showing how data may generally flow between the entities that may participate in the online loyalty program 1. Within program 1, the data flow may be defined with reference to a sponsor 12, a user 20, an affiliated sub-user 32, a non-affiliated sub-user 34, and a sponsor maintained interests database 212.

As shown in FIG. 2, online loyalty program 1 may comprise a reward subsystem 2 and a messaging subsystem 4. The reward subsystem 2 may enable the sponsor 12 to reward the user 20 and a sub-user 30, such as affiliated sub-user 32, such as for engagement in the brand or the online loyalty program 1. The messaging subsystem 4 may enable communication between one or more sub-users 30 and another sub-user 30. Such communication between sub-users may be under the supervision of user 20, who may supervise the activities of affiliated sub-user 32 within the online loyalty program 1. Sub-users, such as affiliated sub-user 32, may provide a lists of interests to a sponsor maintained interests database 212. Examples of interests that a sub-user may provide to database 212 may include the sub-user's favorite sport, hobby, pet, age, favorite character associated with the sponsor's brand, a slogan, a theme, or the like. Sub-users, such as affiliated sub-user 32, may then access the sponsor maintained interests database 212 in order to find other sub users with which the affiliated sub-user desires to engage in communication, such as other sub-users who might share common interests with the affiliated sub-user 32.

In exchange for an activity performed by the user 20, the sponsor 12 may provide a reward to the user 20. The activity may be a first, second, or third activity, wherein first, second, and third may denote the same or different type of activity and may denote the same or different temporal performance of a given activity or activities. The activity may be one of one or more activities defined or identified by sponsor 12. The sponsor 12 may define or identify one or more activities, such as on Web site 100 within the user area 120. The activity may be one which the user performs online using Web site 100. Examples of such activities may include the user 20 using the Web site 100 to purchase a membership for another user, purchase branded products or services, providing the sponsor 12 with identification of other entities, such as those which may purchase branded products for the affiliated sub-user 32, by referring another potential user to the program, by taking a survey, or the like. The activity may involve one or more physical acts by the user such as purchasing and/or using the sponsor's goods and/or services, purchasing a membership for another potential user, or the like.

The reward provided may be in the form of a soft currency or reward points, which the user 20 may later discretionally transfer to one or more affiliated sub-users 32, such as for a reward in exchange for the affiliated sub-user sharing activities with the users 20. Such activities may be defined by the sponsor, such as on the Web site 100, or may be defined by the user 20. Examples of such activities may include, such as when the affiliated sub-user 32 is a child of user 20, performing chores, reading books, such as those associated with the sponsor 12, achieving academically, or the like.

In exchange for an activity performed by a sub-user 30, such as affiliated sub-user 32, the sponsor 12 may provide a reward to the affiliated sub-user 32. The activity may be a first, second, or third activity, wherein first, second, and third may denote the same or different type of activity and may denote the same or different temporal performance of a given activity or activities. The activity may be one of one or more activities defined or identified by sponsor 12, such as on Web site 100 within the sub-user area 130. The activity may be one which the sub-user 30 performs within online using Web site 100. The activity may involve one or more physical acts by the sub-user. Examples of activities for which a sub-user 30 may earn rewards from sponsor 12 may include various projects that an affiliated sub-user 32 may perform for the user 20. When the affiliated sub-user 32 is the child of the user 20, such projects may include preparing a meal with a parent, participation in a family cleaning project, modifying a toy associated with the brand, such as giving a doll a new hairstyle, engaging in pretend activities involving toys associated with the brand, such as pretending that a house is a beauty salon, finding a new friend such as by using the sponsor maintained interests database 212, telling a friend about the program, bringing a toy associated with the brand to school for show and tell, involving other children in play with toys associated with the brand, trading an online trading card with another sub-user, volunteering in a community activity, reading one or more books, such as those associated with the brand, visiting a physical location associated with the brand, such as a headquarters or retail location, attending a theatrical presentation at the physical location, having photos taken at the physical location, such as of the affiliated sub-user 32 and/or of products associate with the brand, having maintenance done on a toy at the physical location eating a meal at the physical location, attending a special event and/or class at the physical location, or the like. The reward provided to the affiliated sub-user 32 may include reward points, which the affiliated sub-user 32 may redeem to the sponsor 12, such as in exchange for branded products or services.

As part of the supervisory aspects of the program 1, user 20 may be able to approve or deny the distribution of any reward to an affiliated sub-user 32, such as because the affiliated sub-user 32 did not perform the defined activity as required.

The messaging subsystem 4 of online loyalty program 1 may enable the affiliated sub-user 32 to communicate with one or more other sub-users, as shown in FIG. 2. The one or more other sub-users may be other sub-users affiliated with user 20 or may a non-affiliated sub-user 34 in that the other sub-user is not affiliated with user 20. The messaging subsystem 4 may enable one or more sub-users to locate other sub-users having shared interests, such as by providing a sponsor maintained interests database 212, as discussed above. Affiliated sub-user 32 may access the interests database 212, such as after affiliated sub-user 32 has provided information into the database, to find other sub-users with whom the affiliated sub-user 32 desires to exchange messages. The affiliated sub-user 32 may choose another sub-user to engage in communication for any reason, such as common or distinct interests as embodied in the interests database 212.

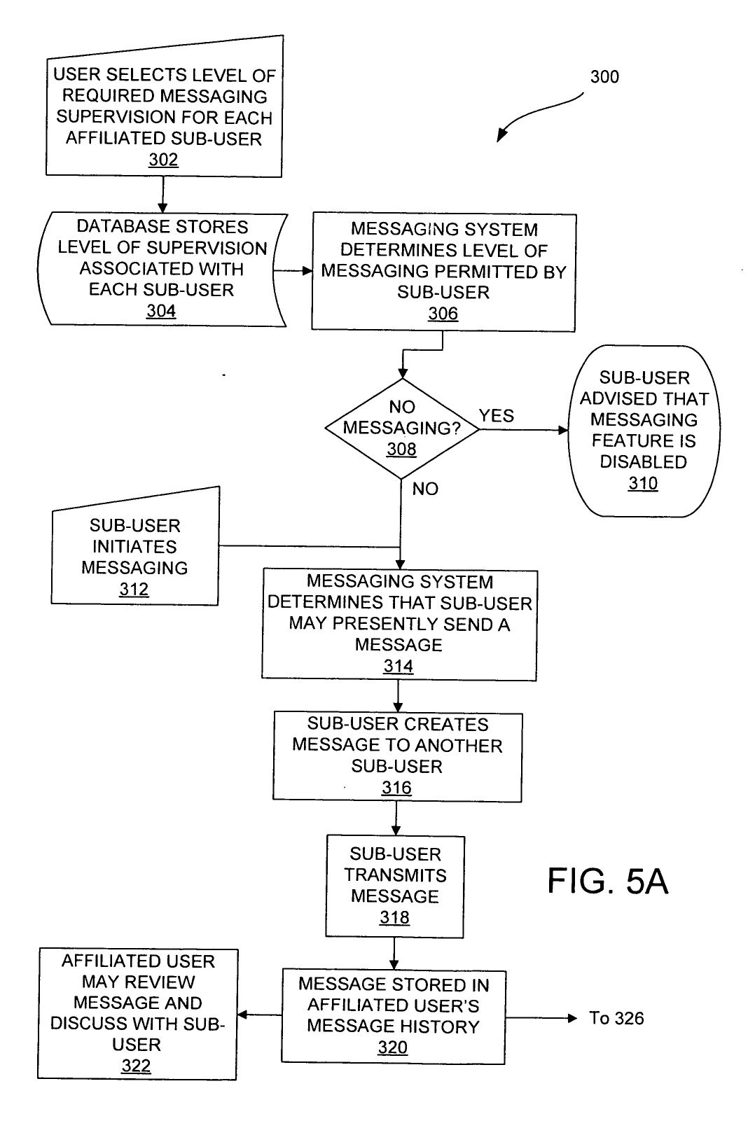

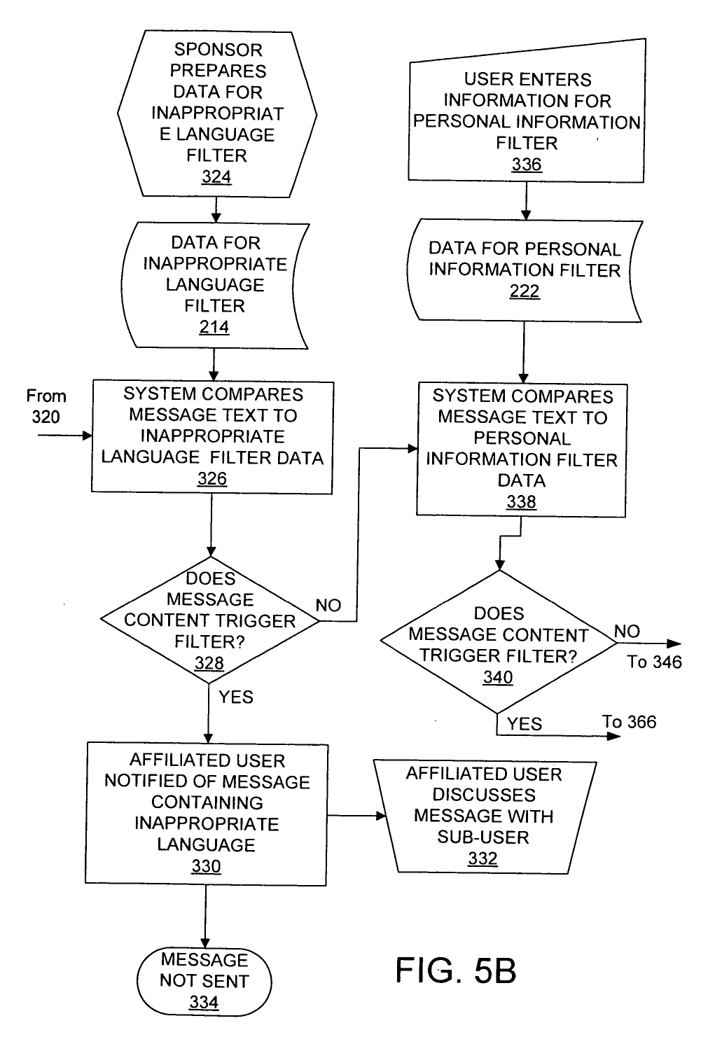

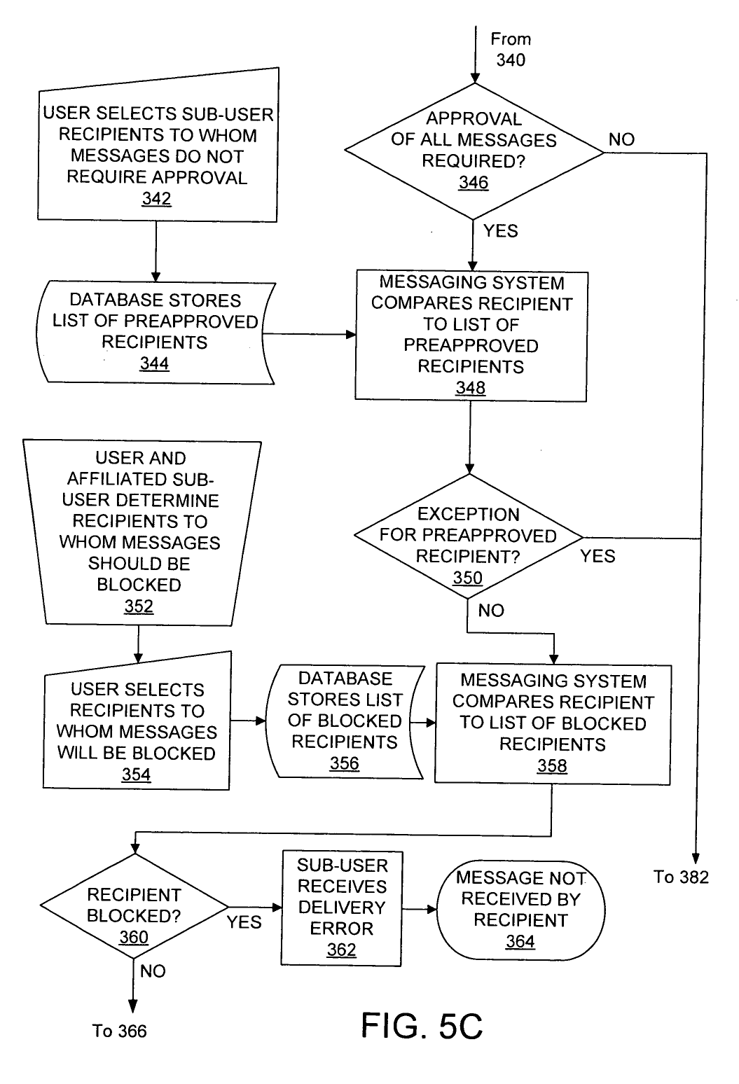

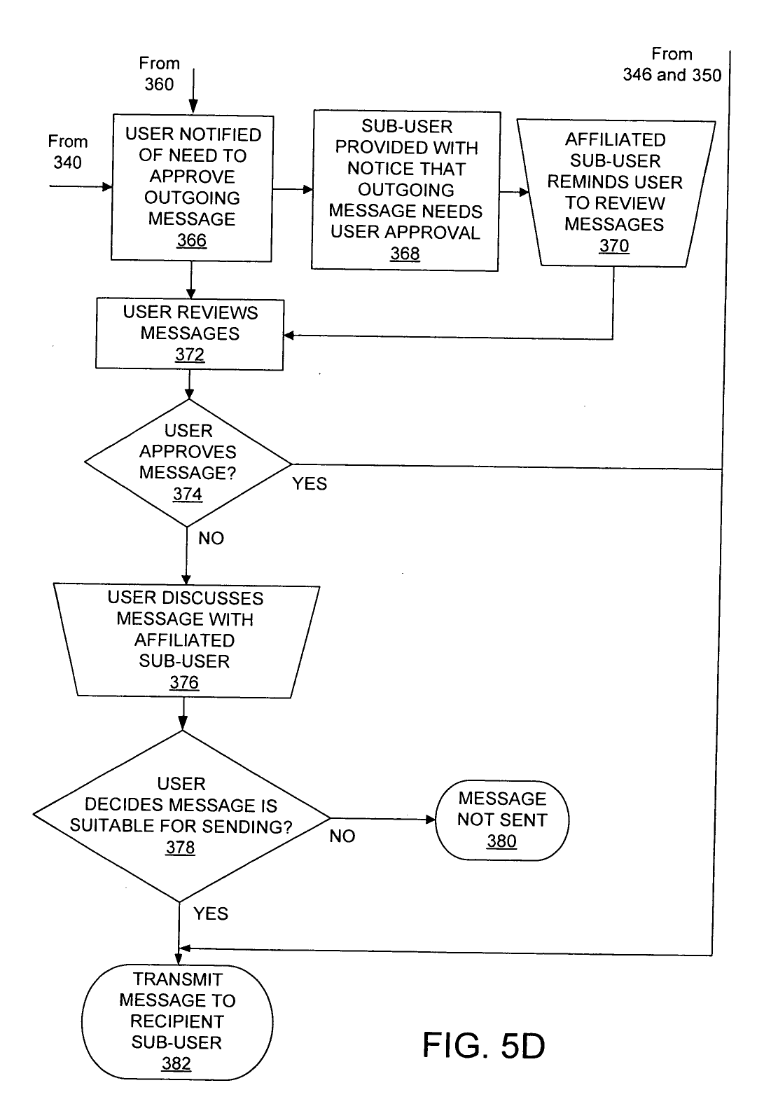

To assure the security of the messaging subsystem 4, as well as to provide protection to sub-users, such as when the sub-users are minors, messaging subsystem 4 may enable user 20 to supervise the affiliated sub-user's participation in the messaging subsystem 4, as illustrated in FIGS. 5A-7D and discussed below.

FIG. 3A illustrates another embodiment of the reward subsystem 2 of online loyalty program 1. As part of the reward system, sponsor 12 may provide brand related online content such as animated virtual trading cards, which may have rich narrative content and affinity for characters associated with the brand associated with sponsor 12. Brand related online content may include any number of online activities, which may be either individual or communal in nature, such as games, special events for participants in the program, or the like.

As discussed above, an affiliated sub-user 32 may accrue rewards, which may be in the form of a soft currency or reward points, from either the sponsor 12 or user 20 in return for the affiliated sub-user 32 engaging in brand related activities. The reward subsystem 2 may enable the affiliated sub-user 32 to redeem the reward points to the sponsor 12 in exchange for brand related merchandise, which may be either tangible or virtual. Examples of tangible or real merchandise may include products or services associated with the sponsor, such as branded products or services including logo clothing, or the like. Examples of virtual merchandise may include enhanced functionality of the for the sub-user area 130 of Web site 100 with respect to the affiliated sub-user 32, such as providing access to additional space for the affiliated sub-user 32 to collect and store virtual trading cards or other online content, or the like.

Sponsor 12 may additionally collect information from or about the activities of affiliated sub-user 32 within the online environment. Such information may be gathered in the form of surveys or other tracking of the affiliated sub-user's online activities. Sponsor may provide information, such as information related to the activities of the affiliated sub-user 32 within the online environment to the user 20. User 20 may use the provided information as needed, such as to supervise the affiliated sub-user's activities.

As discussed above, user 20 may receive reward points from sponsor 12, such as for performing specified activities. User 20 may distribute these reward points to the affiliated sub-user 32, who may redeem the points to the sponsor in exchange for merchandise, as discussed above. The reward subsystem 2 of the online loyalty program 1 may also enable the user 20 to supervise the affiliated sub-user 32, such as by approving reward point transaction attempted by the affiliated sub-user 32. For example, user 20 may block attempts by the affiliated sub-user 32 to redeem reward points in exchange for merchandise. User 20 may exercise further supervision over the online activities of the affiliated sub-user 32 by virtue of providing supervision over the affiliated sub-user's participation in messaging subsystem 4.

FIG. 3B illustrates another embodiment of the messaging subsystem 4 online loyalty program 1. Using the messaging subsystem 4, affiliated sub-user 32 may exchange messages with one or more other sub-users 30, such as another affiliated sub-user or one or more non-affiliated sub-users 34. Affiliated sub-user 32 may locate suitable other sub-users to engage in communications such as through use of the sponsor maintained interests database 212, as described above.

FIG. 4 schematically illustrates another embodiment of system 10 for increasing consumer affinity for a brand, which may comprise at least part of an online loyalty program 1. The embodiment of system 10 as illustrated in FIG. 4 may generally contain at least some of the same features and functionality as discussed above with respect to FIG. 1.

As discussed above, user area 120 of Web site 100 may include a supervision interface 122. The supervision interface may include a messaging supervision interface 124, and reward points supervision interface 126. As a part of system 10, each user may have associated therewith a user account 220 stored in database 200, which may include data for personal information filter 222, a reward point balance 224, a message history 226, messaging supervision settings 228, or the like.

The messaging supervision interface 124 may provide user 20 with the ability to exercise control over the messaging activities of affiliated sub-user 32. For example, messaging supervision interface 124 may enable user 20 to disable the messaging subsystem 4 relative to one or more affiliated sub-users. The messaging subsystem 4 may enable user 20 to approve one or more messages sent or received by affiliated sub-user 32.

User supervision over the messaging activities of affiliated sub-user 32 may be supported by one or more content filters included within messaging subsystem 4 of system 10, such as a personal information filter an inappropriate language filter, a personal information filter, or the like. Messaging subsystem 4 may compare the content of messages that affiliated sub-user 32 has attempted to send against one or more of the filters in order to determine whether or not the message contains information that should not be sent. If a message contains information that should not be sent, the message might not be sent and/or the user 20 may be given an opportunity to approve the message prior to sending.

The personal information filter may be configured to prevent an affiliated sub-user 32 from sending messages containing information that a user 20 affiliated with the affiliated sub-user 32 has determined should not be included in any messages the affiliated sub-user 32 sends using the messaging subsystem 4. In particular, the personal information filter may enable the user 20 to prevent an affiliated sub-user 32 from sharing selected information with other sub-users. User 20 may enter various information into the database 200, which may then be stored as data for a personal information 222 within the user account 220. User 20 may enter such data through Web site 100, such as by using the supervision interface 122. Exemplary information a user 20 may enter into the data for an inappropriate language filter 214 may include information tending to personally identify affiliated sub-user 32, such as the affiliated sub-user's name, address, phone number(s), nicknames, e-mail addresses(s), school, any other items user 20 wants to keep private, or the like. The user 20 may alter, add, or subtract from this information as often as desired. The personal information filter may apply to all sub-users affiliated with user 20. Such information as embodied in the data for a personal information filter 214 need not be case sensitive.

The inappropriate language filter may be configured to prevent an affiliated sub-user 32 from sending messages containing data, such as words, images, or the like, which the sponsor deems to be inappropriate subject matter. Data for inappropriate language filter 214 may be stored in database 200 on server 50. Examples of suitable data for the inappropriate language filter 214 may include so-called “bad” words, curse words, or any other language, strings of characters or data, images, or the like, that sponsor 12 may have deemed to be content inappropriate for inclusion in messages exchanged between sub-users using the messaging subsystem 4 of the online loyalty program 1.

User account 220 may include a message history 226. Message history 226 may store some or all of the messages received by the affiliate sub-user 32, such that user 20 may review some or all of the received messages. Message history may store at least some of the messages sent by affiliated sub-user 32 to other sub-users.

The messaging subsystem 4 may be configured to enable user 20 to establish a level of required supervision and/or required supervisory actions over the messaging activities of an messaging subsystem 4. For example, the messaging portion 124 of the supervision interface 122 of the user area 120 of Web site may be configured to enable user 20 to establish a level of required supervision and/or required supervisory actions. The level of required supervision and/or required supervisory actions may be recorded in the messaging supervision settings 228 within user account 220.

The reward points supervision interface 126 may provide user 20 with the ability to exercise control over the reward point transactions carried on by an affiliated sub-user 32 within the reward subsystem 2. For example, the reward points supervision interface 126 may enable user 20 to approve the issuance of reward points to an affiliated sub-user 32 from sponsor 12 or the redemption of reward points by affiliated sub-user 32 to sponsor 12 in exchange for merchandise. The reward points supervision interface 126 may enable user 20 to view a record of the reward point transactions of an affiliated sub-user 32. The reward points supervision interface 126 may enable user 20 to access a reward point balance 224, which may be stored in database 200 within user account 220, such that user 20 may view reward point balance 224. Reward point supervision interface 126 may enable user 20 to access a reward point balance 224, such that user 20 may direct reward subsystem 2 to transfer one or more reward points from the user's reward point balance 224 to a reward point balance 232 of an affiliated sub-user 32.

As discussed above, sub-user area 130 of Web site 100 may include a messaging interface 132, a provision for access to online content 134, access to reward point functionality 136, and the like. As a part of system 10, each sub-user may have associated therewith a sub-user account 230 stored in database 200, which may include a reward point balance 232, a message inbox 234, an interests list 236, a contacts list 238, or the like.

Messaging interface 132 may be configured to enable a sub-user 30 to utilize the messaging subsystem 4 of online loyalty program 4, such as by enabling sub-user 30 to access message inbox 234 to view messages that sub-user 30 has received from other sub-users. Messaging interface 132 may be configured to provide an affiliated sub-user 32 with notice that messages have been received from other sub-users but require approval by user 20. Messaging interface 132 may be configured to enable sub-user 30 to create messages to other sub-users and may also provide an affiliated sub-user 32 with notice that outgoing messages require user approval prior to transmission.

The sub-user area 130 may be configured to enable a sub-user to create and access an interests list 236 and a contacts list 238, which may be stored within the user account 230 in the database 200. Interests list 236 may include a list of such items as the sub-user's favorite sport, hobby, pet, age, favorite character associated with the sponsor's brand, a slogan, a theme, or the like. Interests list 236 may also be reflected or stored within the sponsor maintained interests database 212. A sub-user 30 may access and maintain a contacts list 238, which may contain a list of other sub-users with whom sub-user 30 desires to exchange messages. Sub-user 30 may create the contacts list 238 based on messages sub-user 30 has received from other sub-users or other sub-users whom sub-user 30 has identified based on accessing the sponsor maintained interests database 212.

The sub-user area 130 may be configured to provide sub-user 30 with access to online content 134 provided on Web site 100, as discussed above. Online content 134 may include access to a sponsor maintained interests database 212 where a sub-user may locate other sub-users with whom sub-user 30 desires to exchange messages, as discussed above.

The sub-user area 130 may include a reward points area 136, which may be configured to provide sub-user 30 with access to a reward point balance 232, which is stored within the sub-user account 230 associated with sub-user 30. Reward point balance 232 may provide an affiliated sub-user 32 with a record of the reward points issued to affiliated sub-user 32 by the sponsor 12 or transferred to the reward point balance 232 of the affiliated sub-user 32 from the reward point balance of the user 20 affiliated with the affiliated sub-user 32. The reward points area 136, may be configured enable the affiliated sub-user 32 to redeem reward points to the sponsor 12 in exchange for merchandise from the sponsor and to view a record of the affiliated sub-user's redemption transactions.

FIGS. 5A-5D illustrate a flow chart of an outgoing message process 300 at least partially suitable for implementation a messaging subsystem 4 of system 10. As indicated in block 302, the user 20 may select a level of required messaging supervision for each affiliated sub-user. User 20 may make such selection such as by using supervision interface 122 in user area 120 of Web site 100. An indication of the user's selection made at block 302 may be stored in user account 220, such as within the messaging supervision settings 228, as indicated in block 304, where the database may store a level of supervision associated with each sub-user affiliated with user 20. When an affiliated sub-user 32 attempts to send a message, as indicated at block 306, the server 50 may determine the level of messaging user 20 has permitted affiliated sub-user 32 to utilize. At block 308, server 50 may determine whether affiliated sub-user 32 is to be denied access to the messaging system. If user 20 determines that affiliated sub-user 32 should not participate in the messaging functionality, affiliated sub-user 32 may be advised that the messaging feature is disabled, as indicated at block 310. If user 20 has instructed server 50 to permit affiliated sub-user 32 access to the messaging functionality, affiliated sub-user 32 may initiate messaging, such as through messaging interface 132 of the sub-user area 130 of Web site 100, as indicated at block 312. In some embodiments of messaging system, the messaging system may determine whether sub-user may presently send a message, as indicated at block 314, prior to affiliated sub-user 32 creating a message to another sub-user, which may be a non-affiliated sub-user 34 or another sub-user affiliated sub-user 32 with user 20, as indicated at block 316.

Once affiliated sub-user 32 has created a message to another sub-user 32, the affiliated sub-user 32 may utilize the messaging interface 132 to transmit the message to the recipient, as indicated in block 318. At least some of the messages transmitted by affiliated sub-user 32 may be stored in the affiliated user's message history 226, as indicated in block 320. As indicated in block 322, user 20 may review messages sent by affiliated sub-user 32, which are stored in message history 226. User 20 may determine that the content of one or more messages sent by affiliated sub-user 32 might not be appropriate. If so, user 20 may discuss any such messages with affiliated sub-user 32, as indicated in block 322.

As indicated in block 324, sponsor 12 may prepare or compile data for an inappropriate language filter 214, which data may be stored in database 200 on server 50. Prior to transmitting a message sent by affiliated sub-user 32, system 10 may compare the text, or other content, of the message to the data in the inappropriate language filter, as indicated in block 326. At block 328, system 10 may determine whether the content of the message triggers the inappropriate language filter. If at least part of the message content matches the data for the inappropriate language filter 214, system 10 may provide user 20, who is affiliated with affiliated sub-user 32, with notice that a message sent by affiliated sub-user 32 contained inappropriate material, as indicated in block 330. Such notification may be by any suitable method, such as through the supervision interface 122, by email to the users 20, or the like. Once notified of such a message having inappropriate content, user 20 may discuss the content of the message with affiliated sub-user 32, as indicated in block 332. System 10 may be configured such that a message containing inappropriate data is not sent to the intended recipient, as indicated in block 334, such that the intended recipient may not be made aware that another sub-user attempted to send a message containing inappropriate data. System 10 may be configured such that a message containing inappropriate data is not brought to the attention of sponsor 12, such that user 20 may address the inappropriate nature with the affiliated sub-user as user 20 desires.

As indicated in block 336, a user 20 may enter information for use in a personal information filter, which may be stored within user account 220 in database 200 as data for personal information filter 222. User may enter such information using any appropriate method, such as through supervision interface 122 in the user area 120 of Web site 100. As indicated at block 338, system 10 may compare the text of each message the affiliated sub-user 32 attempts to send to other sub-users to the data for an inappropriate language filter 214, to determine whether the content of the messages triggers the filter, as indicated at block 340. If some part of the message content triggers the filter, user 20 may be required to approve the message prior to transmission, with user 20 being provided with notice of the need to approve an outgoing message, as indicated in block 366. If the message content does not trigger the filter, the message may advance through subsystem 4, as described below.

As indicated at block 346, user 20 may configure the messaging supervision settings 228, which are stored in the user's account 220, with respect to any one of the sub-users affiliated with user 20 such that all messages sent by affiliated sub-user 32 must be approved by user 20. If user 20 does not require such approval, messages created by the affiliated sub-user 32, which have not triggered one of the aforementioned content filters, may advance to transmission to the intended recipient sub-user, as indicated in block 382.

Rather than precluding an affiliated sub-user 32 from using the messaging subsystem or allowing unsupervised messaging, where user 20 may not have to approve any messages, unless the message triggers the content filter, the user may select various levels over the affiliated sub-user's use of the messaging subsystem 4. Such a selection may be stored in the messaging supervision settings 228 within the user's account 220 in the database 200, and may be individually configured with respect to each sub-user affiliated with user 20. As indicated in block 346, user 20 may determine that all messages sent by affiliated sub-user 32 require approval. However, as indicated at block 342, user 20 may select one or more sub-user recipients to whom messages sent by the affiliated sub-user 32 do not require approval. A list of preapproved recipients, to whom messages from affiliated sub-user 32 do not require approval, may be stored in database 220, such as within messaging supervision settings 228, as indicated in block 344. When approval of all messages is required, the messaging subsystem 4 may compare the intended recipient to the list of preapproved recipients to determine if the recipient is preapproved, as indicated in blocks 348 and 350. If the recipient is preapproved, the message may advance to transmission to the intended recipient sub-user, as indicated in block 382.

As indicated in block 352, the user 20 and any sub-user affiliated therewith may determine other sub-users to whom messages from the affiliated sub-user 32 should be blocked, such as because the user 20 determines that affiliated sub-user 32 should not communicate with that other sub-user. User 20 selects recipients to whom messages will be blocked such as by using the messaging portion 124 of supervision interface 122, as indicated in block 354. As indicated in block 356, a list of blocked recipients may then be stored on database 200, such as in user account 220 within the messaging supervision settings 228. The messaging subsystem 4 may then compare the intended recipient of a massage sent by the affiliated sub-user 32 against the list of blocked recipients, as indicated in blocks 358 and 360. If the recipient is blocked, affiliated sub-user 32 may receive a delivery error, as indicated in block 362, and the message may not be received by the intended recipient, as indicated in block 364. Conversely, if the recipient is not blocked, user 20 may then be notified of a need to approve an outgoing message, as indicated in block 366. In addition to notice to user 20, affiliated sub-user 32 may also receive notice that one or more outgoing messages may require user approval prior to transmission, as indicated in block 368. Upon receipt of such notice, affiliated sub-user 32 may prompt user 20 of the need to review outgoing messages, as indicated in block 370.

Prior to transmission, user 20 may review and approve the messages sent by affiliated sub-user 32, as indicated in blocks 372 and 374. If user 20 approves the message, the message may advance to transmission to the intended recipient sub-user, as indicated in block 382. If user 20 does not approve the message, such as because user 20 determines that the message contains information that should not be sent to other sub-users, or the like, user 20 may discuss the message with affiliated sub-user 32, as indicated in block 376. After discussing the message with affiliated sub-user 32, user 20 may determine that the message is suitable for sending, such as because the contents of the message are not inappropriate, as indicated in block 378, in which case the message may advance to transmission to the intended recipient sub-user, as indicated in block 382. Conversely, if user 20 determines that the message is not suitable for sending for any reason, user 20 may decline to approve the message, in which case the message may not be sent, as indicated in block 380.

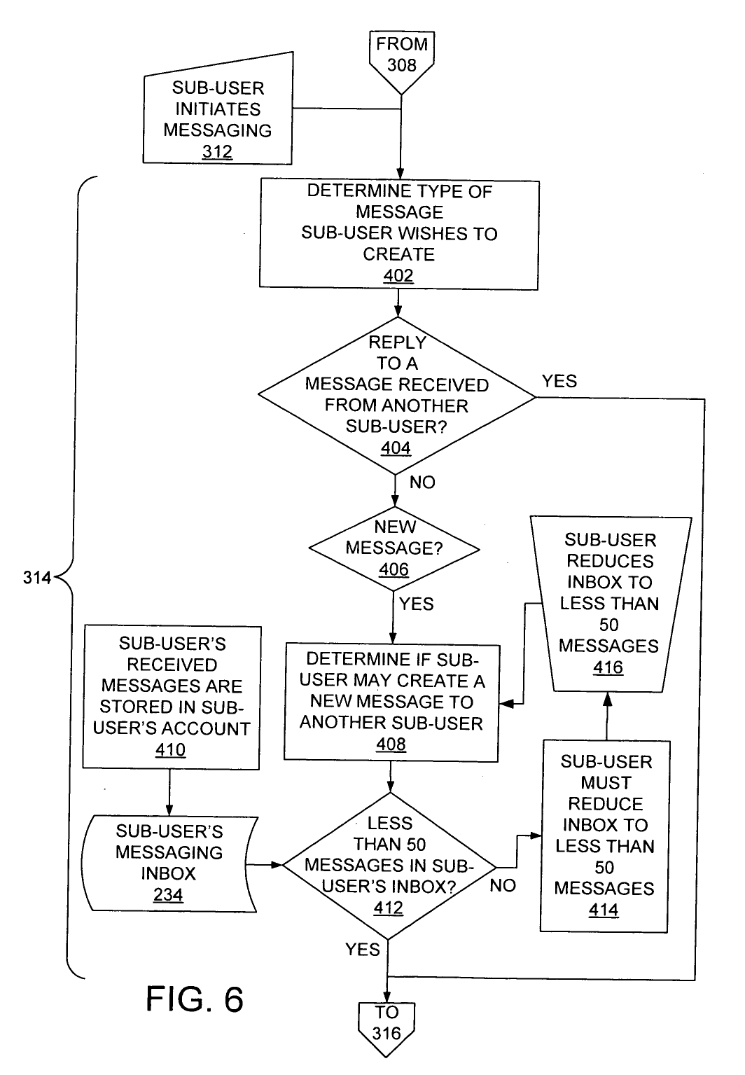

FIG. 6 illustrates a flow chart of a suitable decision process 400, which may be used by the messaging subsystem 4 to determine whether a sub-user may presently send a message 314 using the outgoing message process 300. As shown in FIG. 6, after the system determines that the messaging affiliated sub-user 32 may use the messaging subsystem 4, as indicated in block 308, and the affiliated sub-user 32 has initiated messaging, as indicated in block 312, the messaging subsystem 4 may determine what type of message affiliated sub-user 32 wishes to create, as indicated in block 402. The messaging subsystem may determine that the created message may be a reply to a message the affiliated sub-user 32 received from another sub-user, as indicated in block 404, in which case the messaging subsystem 4 may then permit the affiliated sub-user 32 to create a message to another sub-user, as indicated in block 316. The messaging subsystem may determine that the created message may be a new message, as indicated in block 406, in which case the messaging subsystem 4 may then determine whether affiliated sub-user 32 may create a new message to another sub-user, as indicated in block 408. As indicated in block 410, the sub-user's received messages are stored in sub-user account 230, such as in a message inbox 234, which may be accessible through the messaging interface 132 of the sub-user area 130 of the Web site 100. As indicated in block 412, the messaging subsystem 4 may determine whether there are less than a predetermined number of messages in sub-user's message inbox 234, such as 50 or any other suitable number. If there are less than the predetermined number of messages in the sub-user's message inbox 234, messaging subsystem 4 may then permit the affiliated sub-user 32 to create a message to another sub-user, as indicated in block 316. Conversely, if there are more than the predetermined number of messages in the sub-user's message inbox 234, messaging subsystem 4 may then require that affiliated sub-user 32 reduce the number of messages in the sub-user's message inbox 234, such as by deleting excess messages, prior to affiliated sub-user 32 to creating a message to another sub-user, as indicated in blocks 414 and 416.

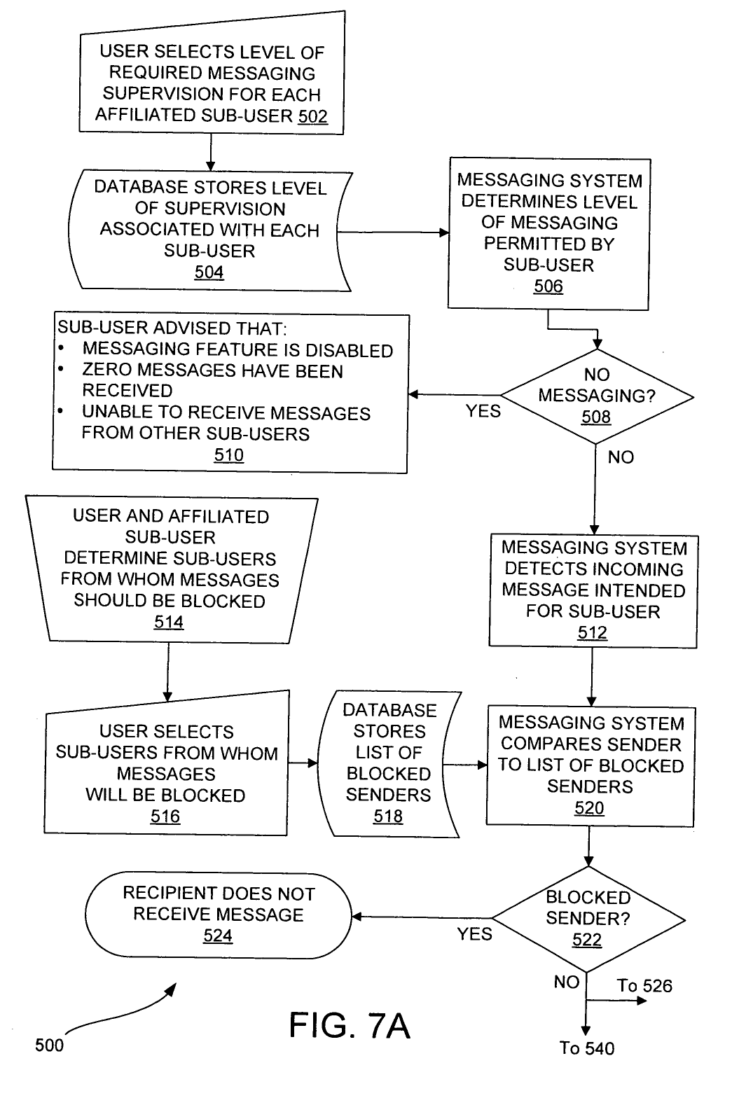

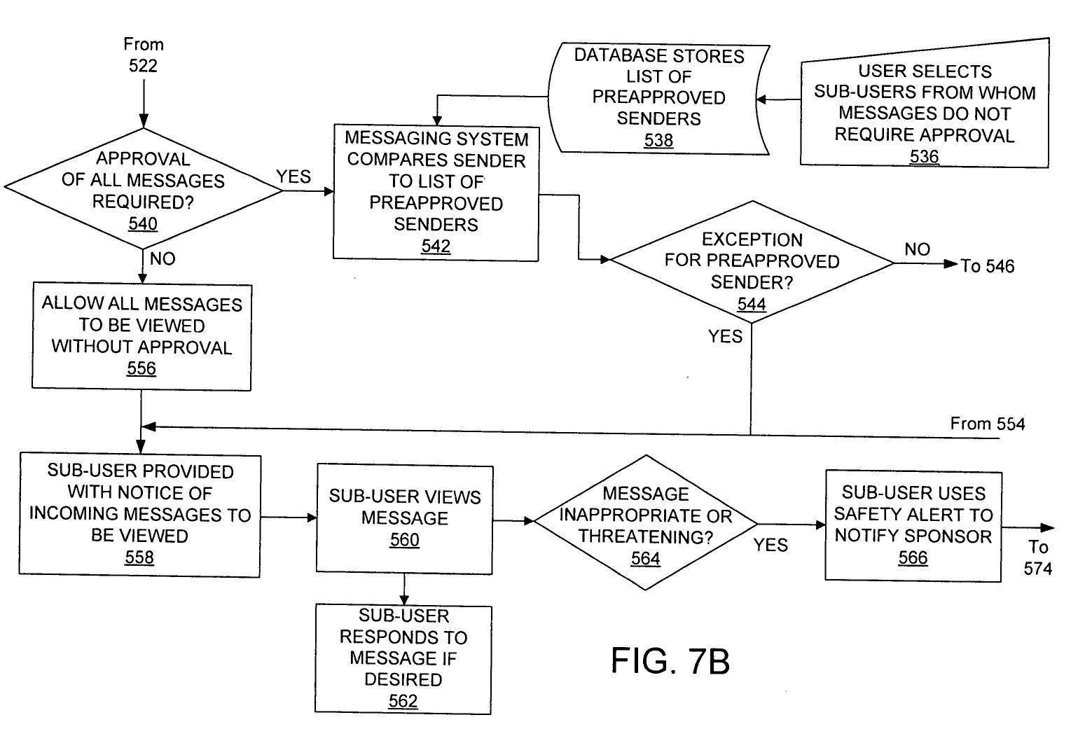

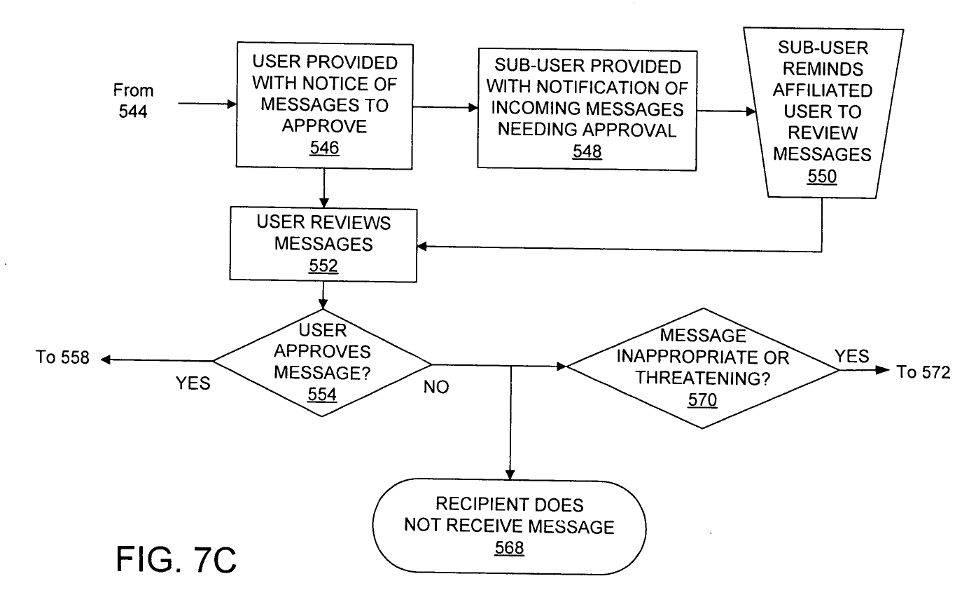

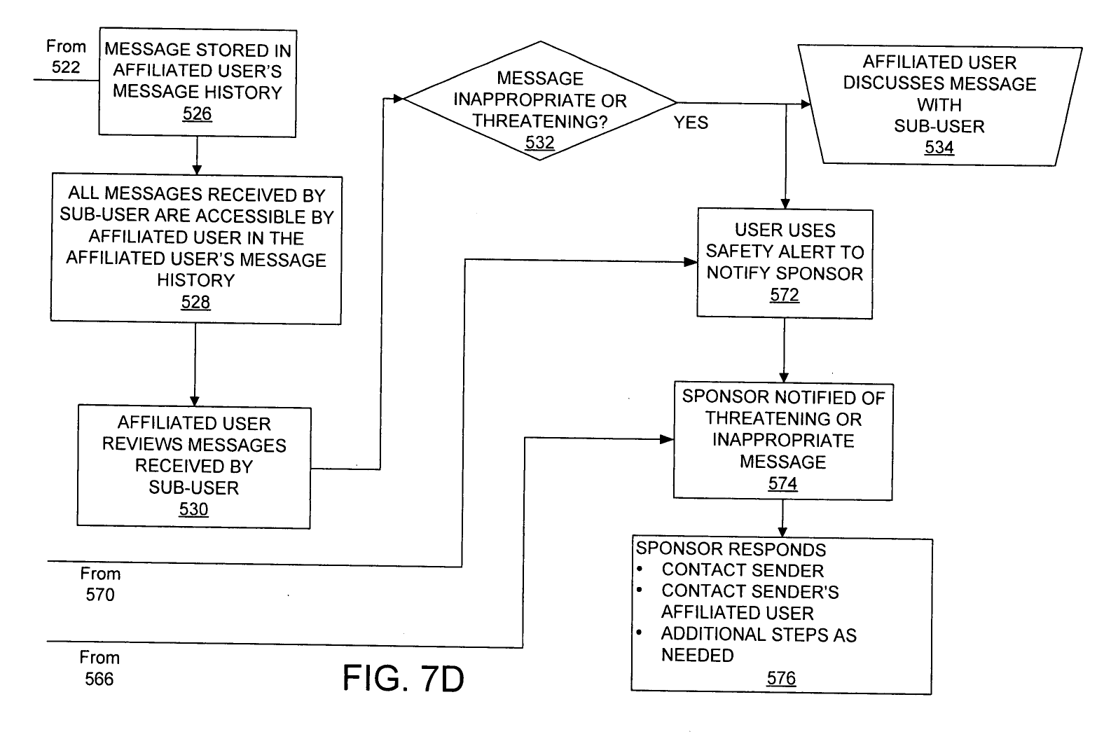

FIGS. 7A-7D illustrate a flow chart of the incoming message process 500 at least partially suitable for implementation a messaging subsystem 4 of system 10. As indicated in block 502, the user 20 may select a level of required messaging supervision for each affiliated sub-user. User 20 may make such selection such as by using supervision interface 122 in user area 120 of Web site 100. An indication of the user's selection made at block 502 may be stored in user account 220, such as within the messaging supervision settings 228, as indicated in block 504, where the database may store a level of supervision associated with each sub-user affiliated with user 20. When an affiliated sub-user 32 attempts to utilize messaging subsystem 4, as indicated at block 506, the server 50 may determine the level of messaging user 20 has permitted affiliated sub-user 32 to utilize. At block 508, server 50 may determine whether affiliated sub-user 32 is to be denied access to the messaging system. If user 20 determines that affiliated sub-user 32 should not participate in the messaging functionality, affiliated sub-user 32 may be advised that the messaging feature is disabled, zero messages have been received, and that the affiliated sub-user 32 is unable to receive messages from other sub-users, as indicated in block 510.

If the affiliated sub-user 32 is permitted to use messaging subsystem 4, the messaging system may detect an incoming message intended for affiliated sub-user 32, as indicated in block 512. As indicated in block 514, the user 20 and any sub-user affiliated therewith may determine other sub-users from whom messages to the affiliated sub-user 32 should be blocked, such as because the user 20 determines that affiliated sub-user 32 should not communicate with that other sub-user. User 20 selects senders from whom messages will be blocked such as by using the messaging portion 124 of supervision interface 122, as indicated in block 516. As indicated in block 518, a list of blocked senders may then be stored on database 200, such as in user account 220 within the messaging supervision settings 228. The messaging subsystem 4 may then compare the sender of a massage sent to the affiliated sub-user 32 against the list of blocked senders, as indicated in blocks 520 and 522.

If the sender is blocked, affiliated sub-user 32 may not receive the message, as indicated in block 524. Such blocking of a sender may be transparent to the sender in that the sender may appear to be sending messages to affiliated sub-user 32, but affiliated sub-user 32 may not receive the messages, with the sender receiving no indication that the message was not received by the affiliated sub-user 32. Rather, sender may assume that any lack of reply messages from affiliated sub-user 32 may be due to the fact that affiliated sub-user 32 may not have replied to the sent message.

Conversely, if the sender is not blocked, the message may be stored in the message history 226 of user 20, as indicated in block 526. Some or all of the messages received by the affiliated sub-user 32 may be accessed and reviewed by the affiliated user in the affiliated user's message history 226, which user 20 may access such as through the messaging portion 124 of the supervision interface 122 in the user area 120 of Web site 100, as indicated in blocks 528 and 530.

When the user 20 reviews the messages received by the affiliated sub-user 32 in the user's message history 226, as indicated in block 530, the user 20 may determine whether the message is inappropriate or threatening, as indicated in block 532. If the message is inappropriate or threatening, user 20 may discuss the message with affiliated sub-user 32, such as regarding the contents of the message or whether the sender should be blocked, as indicated in block 534. Additionally, if the message is inappropriate or threatening, user 20 may use a safety alert feature, as indicated in block 572, which may be provided in the messaging portion 124 of the supervision interface of the user area 120 of Web site 100.

The safety alert feature may be used by the user 20, or the affiliated sub-user 32, to provide the sponsor 12 with notice, as indicated in block 574, that a message the affiliated sub-user 32 received from another sub-user was inappropriate or threatening. The safety alert feature may generate an email to the Sponsor's customer service staff. User 20 may include comments in the email to the sponsor. Upon receipt of the email, the sponsor 12 may review the message at issue, and may take appropriate action, which may include contacting the sender, contacting the user affiliated with the sender, or the like, as indicated in block 576. The sponsor 12 may take any additional steps the sponsor deems necessary such as placing the sender on a probationary status with respect to the system 10, suspending the sender, such as from access to the messaging subsystem 4, expelling the sender from the online loyalty program, or the like. The sponsor 12 may notify the user 20 who submitted the safety alert.

The user 20 may determine whether all messages sent to the affiliated sub-user 32 may require approval prior to the affiliated sub-user 32 viewing the message, as indicated in block 540. If user 20 does not require approval of all messages sent to the affiliated sub-user 32, messaging subsystem 4 may allow the affiliated sub-user 32 to view all incoming messages with approval of user 20, as indicated in block 556. In such a case, when the affiliated sub-user 32 receives a message from another sender, such as in the message inbox 234 of the affiliated sub-user's sub-account 230, the affiliated sub-user 32 may be provided with notice of incoming messages to be read, as indicated in block 558.

If user 20 determines that all incoming messages require approval, user 20 may select specific sub-users from whom messages do not require approval, as indicated in block 536. A list of preapproved senders, from whom messages to affiliated sub-user 32 do not require approval, may be stored in database 220, such as within messaging supervision settings 228, as indicated in block 538. When approval of all incoming messages is required, the messaging subsystem 4 may compare the sender of an incoming message to the list of preapproved senders to determine if the sender is preapproved, as indicated in block 542 and 544. If the sender is preapproved, the affiliated sub-user 32 may be provided with notice of incoming messages to be read, as indicated in block 558. message may advance to transmission to the intended recipient sub-user, as indicated in block 382. If the sender is not preapproved, user 20 may be provided with notice that there are incoming messages needing approval, such as through the messaging portion 124 of the supervision interface 122 in the user area 120 of the Web site 100, as indicated in block 546. In addition to notice to user 20, affiliated sub-user 32 may also receive notice that one or more incoming messages may require user approval prior to viewing by the affiliated sub-user 32, as indicated in block 548. Upon receipt of such notice, affiliated sub-user 32 may prompt user 20 of the need to review outgoing messages, as indicated in block 550.

Prior to the affiliated sub-user 32 viewing an incoming message, the user 20 may review and approve the message, as indicated in blocks 552 and 554. If the user 20 does not approve the message, the affiliated sub-user 32 may not receive the message, as indicated in block 568, and the user 20 may determine whether the message is inappropriate or threatening, as indicated in block 570. If the message is inappropriate or threatening, the user 20 may utilize the safety alert feature to notify the sponsor, as indicated in block 572 and discussed above.

If user 20 approves the message, the affiliated sub-user 32 may be provided with notice of an incoming message to be viewed, as indicated in block 558. Affiliated sub-user 32 may then view the received message, as indicated in block 560, and the affiliated sub-user 32 may respond to the sender of the message, if the affiliated sub-user 32 so desires, as indicated in block 562. If the affiliated sub-user 32 determines that the message is inappropriate or threatening, as indicated in block 564, the affiliated sub-user 32 may utilize the safety alert to notify sponsor, as indicated in block 566 and discussed above.

Software embodying the disclosed systems and methods may be executed on a server computer or on one or more client computers, the reason being to enhance performance given present hardware and communications constraints. The systems and methods of this disclosure may be implemented completely at a central facility remote from the client computer, with the client computer running only a communication interface and Internet browser, that is, the system and method may be provided as an Internet service, where the only software executing on the client computer is an Internet browser, such as those available from Microsoft®, Netscape® and other similar providers. Suitable client computers are not limited to traditional computers, and the systems and methods disclosed herein may implemented using any appropriate device capable of connecting to and communicating over a computer network. For example, the systems and methods may be implemented based on an Internet TV appliance, where the users and sub-users interact, essentially, using a remote control for selection and response. The systems and methods may also be implemented on any other suitable device capable of connecting to a computer network, such as cellular phones or other wireless hand-held devices such as the Blackberry® or other similar devices.

In some embodiments, the software associated with the systems and methods of the present disclosure may be executed partially or entirely on one or more client computers. In such embodiments, user preferences information might be stored at a client computer instead of or in addition to being stored at a central facility associated with the sponsor. The reward point balances associated with the users and affiliated sub-users might also be stored on one or more client computers. The online content might also be provided locally at the client computer, such as on CD-ROMs, DVD-ROMS or any other suitable storage medium capable of storing such content. At least a portion of the history of the user's and/or the affiliated sub-user's activities might also be stored locally on one or more client computers. In such an embodiment, access to a central facility can be simplified and used less frequently. Access to a central facility might be used, for example, only to have reward points issued by the sponsor or to redeem reward points to the sponsor.

Similarly, the communications subsystems of the systems and methods of the present disclosure might also be implemented at a local level, such that interaction between the central facility and one or more client computers may be reduced or eliminated. In such embodiments, online content may be provided on CD-ROMs, DVD-ROMS or any other suitable storage medium capable of storing such content, or as content downloaded from one or more remote sources. All interaction with the user and/or sub-user may take place locally at the client computer. In such situation, at least part of the functionality of the systems and methods could be executed such as when no connection to a computer network might be made. The client computer may provide rewards such as from a cache of reward points stored securely on the client computer. When all the available reward points in the cache have been issued to the user and/or sub-user, the user and/or sub-user may continue using online content without receiving reward points, or the reward point functionality could be at least temporarily disabled, such as until the cache might be replenished such as by establishing communication with a central facility.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where any claim recites “a” or “a first” element or the equivalent thereof, such claim should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

We claim:

1. A system for increasing consumer affinity for a brand associated with a sponsor, comprising a server computer hosting a Web site, wherein the server computer is configured to:
enable a user and a sub-user affiliated with the user to access the Web site over a computer network through a client computer;
store data in a database, wherein the data comprises:
a user account having a reward point balance associated therewith for the user; and
one or more sub-user accounts affiliated with the user account, each affiliated sub-user account having a reward point balance associated therewith for the affiliated sub-user;
enable the sponsor to credit one or more reward points to the user account in exchange for the user performing a first activity defined by the sponsor;
enable the sponsor to credit one or more reward points to the affiliated sub-user account in exchange for the affiliated sub-user performing a second activity defined by the sponsor;
enable the user to distribute one or more reward points from the user account to at least one of the affiliated sub-user accounts; and
enable the affiliated sub-user to redeem one or more reward points to the sponsor in exchange for merchandise.

2. The system of claim 1, wherein the user is a parent or guardian of the affiliated sub-user.

3 The system of claim 1, wherein the merchandise comprises one or more tangible products.

4. The system of claim 3, wherein the one or more of the tangible products are associated with the sponsor's brand.

5. The system of claim 1, wherein the merchandise comprises one or more virtual products.

6. The system of claim 5, wherein at least one of the virtual products comprises enhanced functionality in use of the Web site by the affiliated sub-user.

7. The system of claim 1, wherein one or more of the first activities defined by the sponsor is a physical act by the user.

8. The system of claim 7, wherein the physical act includes the user traveling to a physical location associated with the sponsor.

9. The system of claim 1, wherein one or more of the second activities defined by the sponsor is a physical act by the affiliated sub-user.

10. The system of claim 1, wherein one or more of the second activities defined by the sponsor includes the affiliated sub-user executing a virtual task through the Web site.

11. The system of claim 1, wherein the Web site provides one or more online activities to the affiliated sub-user.

12. The system of claim 11, wherein the one or more online activities involve interaction with one or more other sub-users.

13. The system of claim 12, wherein the server computer is configured to enable the user to supervise the affiliated sub-user's participation in the online activities.

14. The system of claim 12, wherein one or more of the other sub-users involved in the one or more online activities is not affiliated with the user.

15. The system of claim 1, wherein the Web site provides narrative content to the affiliated sub-user.

16. The system of claim 1, wherein the server computer enables the user to exercise control over the reward point balance of the affiliated sub-user.

17. The system of claim 16, wherein the user account includes a history tracking one or more of the affiliated sub-user's reward point transactions.

18. The system of claim 16, wherein the server computer enables the user to prevent the sponsor from crediting one or more reward points to the affiliated sub-user's reward point balance.

19. The system of claim 16, wherein the server computer enables the user to prevent the sub-user from redeeming one or more reward points to the sponsor.

20. The system of claim 1, wherein the Web site enables the affiliated sub-user to exchange messages with one or more other sub-users.

21. The system of claim 20, wherein the Web site enables the user to exercise control over the affiliated sub-user's exchange of messages with the one or more other sub-users.

22. A method for increasing consumer affinity for a brand associated with a sponsor, comprising:
providing a server computer accessible over a computer network;
storing data on the server computer in a database, wherein the database comprises:
a user account having a reward point balance associated therewith for a user; and
one or more sub-user accounts affiliated with the user account, each affiliated sub-user account having a reward point balance associated therewith for a sub-user affiliated with the user;
crediting one or more reward points to the user account in exchange for the user performing an activity defined by the sponsor;
transferring, at the request of the user, one or more reward points from the user account to at least the one affiliated sub-user account;
crediting one or more reward points to at least the one affiliated sub-user account in exchange for the affiliated sub-user performing an activity defined by the sponsor;
redeeming, at the request of the affiliated sub-user, one or more reward points from at least the one affiliated sub-user account to the sponsor in exchange for merchandise.

23. The method of claim 22, further comprising providing one or more online activities to the affiliated sub-user.

24. The method of claim 23, wherein providing the one or more online activities includes providing online interaction between the affiliated sub-user and one or more other sub-users.

25. The method of claim 22, further comprising providing the user with a supervision interface enabling the user to exercise control over one or more of the affiliated sub-user's reward point transactions.

26. The method of claim 25, further comprising creating a reward point history in the user account, wherein the reward point history includes a record of one or more of the affiliated sub-user's reward point transactions.

27. The method of claim 25, further comprising enabling the user to prevent the sponsor from crediting one or more reward points to at least the one affiliated sub-user account.

28. The method of claim 25, further comprising enabling the user to prevent the sub-user from redeeming one or more reward points to the sponsor.

29. The method of claim 22, further comprising providing one or more virtual trading cards to the affiliated sub-user.

30. The method of claim 29, further comprising enabling the affiliated sub-user to exchange one or more of the virtual trading cards with one or more other sub-users.

31. The method of claim 22, further comprising enabling the affiliated sub-user to exchange messages with one or more other sub-users.

32. The method of claim 31 further comprising enabling the user to exercise control over the affiliated sub-user's exchange of messages with one or more other sub-users.

33. Storage media having embodied therein a plurality of machine-readable instructions, wherein, when a processor executes the instructions, the instructions provide for:
storing data on a server computer in a database, wherein the database comprises:
a user account having a reward point balance associated therewith for a user; and
one or more sub-user accounts affiliated with the user account, each affiliated sub-user account having a reward point balance associated therewith for a sub-user affiliated with the user;
crediting one or more reward points to the user account in exchange for the user performing an activity defined by the sponsor;
transferring, at the request of the user, one or more reward points from the user account to at least the one affiliated sub-user account;
crediting one or more reward points to at least the one affiliated sub-user account in exchange for the affiliated sub-user performing an activity defined by the sponsor;
redeeming, at the request of the affiliated sub-user, one or more reward points from at least the one affiliated sub-user account to the sponsor in exchange for merchandise.

34. Storage media having embodied therein a plurality of machine-readable instructions adapted to be executed by a computer processor, to:
enable a user and a sub-user affiliated with the user to access a Web site over a computer network through a client computer;
store data in a database, wherein the data comprises:
a user account having a reward point balance associated therewith for the user; and
one or more sub-user accounts affiliated with the user account, each affiliated sub-user account having a reward point balance associated therewith for the affiliated sub-user;
enable the sponsor to credit one or more reward points to the user account in exchange for the user performing a first activity defined by the sponsor;
enable the sponsor to credit one or more reward points to the affiliated sub-user account in exchange for the affiliated sub-user performing a second activity defined by the sponsor;
enable the user to distribute one or more reward points from the user account to at least one of the affiliated sub-user accounts; and
enable the affiliated sub-user to redeem one or more reward points to the sponsor in exchange for merchandise.

35. A system for increasing consumer affinity for a brand, comprising a server hosting an online environment accessible by a user and a sub-user affiliated with the user, wherein the server is configured to:
enable the user to supervise the online activities of the affiliated sub-user;
issue one or more reward points to the user;
enable the user to transfer one or more reward points from the user to the affiliated sub-user;
issue one or more reward points to the affiliated sub-user in exchange for the affiliated sub-user performing an activity specified by the online environment;
enable the affiliated sub-user to redeem one or more reward points in exchange for branded merchandise from an owner of the brand;
provide an online forum enabling the affiliated sub-user to communicate with one or more other sub-users, wherein the server is configured to enable the user to:
supervise the content of messages sent and received by the affiliated sub-user through the online forum;
control to which of the one or more other sub-users the affiliated sub-user may transmit messages through the online forum; and
control from which of the one or more other sub-users the affiliated sub-user may receive messages through the online forum;
maintain a database storing interests associated with the affiliated sub-user and at least one of the one or more other sub-users; and
enable the affiliated sub-user to access the database to select other sub-users whom the affiliated sub-user desires to engage in communication.

36. A method for increasing consumer affinity for a brand associated with a sponsor, comprising:
providing a server hosting an online environment, wherein the online environment enables a user to supervise the activities of an affiliated sub-user within the online environment;
issuing one or more reward points to the user;
transferring, at the request of the user, one or more reward points of the user to the affiliated sub-user;
issuing one or more reward points to the affiliated sub-user in exchange for the affiliated sub-user performing an activity specified by the sponsor;
redeeming, at the request of the affiliated sub-user, one or more reward points of the affiliated sub-user in exchange for branded merchandise from an owner of the brand;
providing an online forum enabling the affiliated sub-user to communicate with one or more other sub-users, the online forum enabling the user to:
review the content of messages transmitted and received by the affiliated sub-user;
select other sub-users to whom the affiliated sub-user may transmit messages; and
select other sub-users from whom the affiliated sub-user may receive messages;
maintaining a database on a computer accessible over a computer network, wherein the database includes interests associated with the affiliated sub-user and at least one of the one or more other sub-users;
enabling the affiliated sub-user to access the database using the online environment; and
enabling the affiliated sub-user to select other sub-users with whom the affiliated sub-user desires to exchange messages using the online forum.
